(19) United States
(12) Patent Application Publication
(10) Pub. No.: US 2012/0136764 A1
(43) Pub. Date: May 31, 2012

(54) ON-LINE TAX PREPARATION APPLICATION SCREEN NAVIGATION USING URL BOOKMARKS

(75) Inventors: Gregory W. Miller, San Diego, CA (US); Beiyu Yang, San Diego, CA (US); Christine M. Ingalls, Escondido, CA (US); James S. Gillespie, San Diego, CA (US)

(73) Assignee: INTUIT INC., Mountain View, CA (US)

(21) Appl. No.: 12/955,800

(22) Filed: Nov. 29, 2010

(51) Int. Cl. G06F 3/048; G06Q 40/00

(52) U.S. Cl. 705/31; 715/760

(57) ABSTRACT

Bookmarking interview screens of an electronic tax return prepared using an on-line tax preparation application. A widget or other element is executed by a user to request a URL bookmark of a screen. A bookmark program of or associated with the on-line tax preparation application dynamically generates a URL bookmark based at least in part upon context data of the screen identifying a path to the screen within hierarchical structure of screens. The URL bookmark is provided to the user and may be utilized to jump to the bookmarked screen without having retracing prior navigation steps through multiple screens before the subject screen. Embodiments may be utilized by technical support persons assisting end users, e.g., by requesting a URL bookmark in the form of a hypertext link and sending the link to a screen to an end user who may click on the link to jump to the bookmarked screen.

### BACKGROUND

The invention relates to Asynchronous JavaScript and XML (AJAX) applications such as tax preparation applications that may be utilized to prepare and file an electronic tax return. Tax preparation applications such as TURBO TAX and TAX CUT have become very popular and allow users to prepare and electronically file a tax return using a computer. During use, a tax preparation application presents tax-related questions or data entry fields to the user as a series of interview pages or screens. In response, the user enters appropriate data or answers if known, and when the tax return is completed, the tax return may be electronically filed with a tax authority.

For example, certain interview screens, fillable forms or questions may relate to personal and family matters such as the user's social security number, marital status, number of dependents, etc. Other interview screens and questions may relate the user's finances such as wages, retirement plan contributions, and social security, state and federal taxes that were paid or withheld as provided in Form-W2. Depending on the type and complexity of the tax return, the user may have to navigate tens, hundreds and even thousands of interview screens, particularly in cases in which a tax return is being prepared for a business or corporate entity.

The manner in which interview screens are displayed to a user is often pre-determined or based on a set path or tree structure. With such structures, certain sequences of interview screens are presented to the user depending on, for example, prior and current interview screens and data or responses to questions provided by the user in one or more prior or current pages or screens. The user may answer questions in various screens along a first path, and when those screens are completed or depending on an answer to a particular question, proceed to a second path, then a third path, and so on, until the tax return is eventually completed.

While tax preparation applications have greatly simplified preparation of tax returns, such applications can be improved in terms of how the screens are navigated by a user. Given that on-line versions of certain tax preparation applications are AJAX applications, such applications have inherent limitations that impact how interview screens are navigated within the pre-determined tree structure.

More specifically, an end user of a tax preparation application may not know or have information or data that is requested in one or more interview screens and thus must navigate to the same interview screen at a later time. The end user may also have a question about a particular screen being currently reviewed. The end user, however, may not know how to navigate back to that particular interview screen and may not even know which interview screen to review. These challenges may be due in part to the large number of interview screens and their pre-determined sequences and tree structure, particularly if the end user is not familiar with the interview screen that must be visited again or located and the desired interview screen is located deep within a tree structure of interview screens such that a user would have to navigate through a large number of interview screens that have already been completed and other and possibly unrelated interview screens before arriving at the interview screen to be reviewed. Thus, it is not uncommon for an end user to locate a screen initially but be unable to locate the same screen at a later time for various reasons, or simply not know where to search for a screen related to a particular topic or tax issue.

Thus, the end user may contact a technical support person who works with the end user to determine which interview screen is necessary and to instruct the user how to navigate to the interview screen, and this assistance is often provided via telephone or on-line via e-mail or chat. The navigation path may be complex, confusing and time consuming depending on, for example, the location of the desired screen, familiarity of the end user with the on-line tax preparation application and the ability of the end user to navigate based on the instructions provided.

These limitations are due in part to on-line tax preparation applications being configured as AJAX applications which, in contrast to traditional web applications, do not allow users to utilize browser navigation to go backwards and forwards and bookmark certain pages, and multiple screens are displayed with a single URL or single webpage. Thus, even if a technical support person is able to locate a screen related to an end user's request, the technical support person must still communicate to the end user how to navigate the multitude of screens to the particular screen located by the technical support person. This can be very frustrating and time consuming for both the end user and the technical support person.

### SUMMARY

One embodiment is directed to a computer-implemented method for generating a URL bookmark of an interview section, screen or page (generally “screen”) of an on-line tax preparation application that is operable to prepare an electronic tax return. Generating the bookmark of an interview “screen” is defined herein as including bookmarking a screen or a location of a screen or definition thereof within a hierarchical or tree structure of a plurality of screens of the tax preparation application, and a “screen” is defined as including an interview screen or page of the on-line tax preparation application. The method may be implemented by a program or module of the on-line tax preparation application or a separate program or controller of or associated with the on-line tax preparation application.

One embodiment of a method comprises determining context data associated with a selected screen (e.g., a currently displayed screen) of the on-line tax preparation application. Context data identifies a path to a location of the selected screen or definition thereof within a hierarchical data structure of a plurality of screens. The method further comprises generating the URL bookmark, e.g., in the form of a Uniform Resource Locator (URL) address or other address that identifies a screen location or a hyperlink, hypertext link or web link (generally, “link”) embodying the URL address. With embodiments, the URL bookmark can be utilized such that the user, at a later time, can click on the link from within other applications to access the selected screen, or enter or copy and paste the URL address into a browser address field, to navigate directly to the URL bookmarked screen. Thus, the user does not have to retrace navigation through a pre-determined sequence of prior screens along the path to the selected screen.

Another embodiment is directed to a computer-implemented method for bookmarking a section, screen or page of an on-line tax preparation application hosted by a first computer and operable to prepare an electronic tax return and comprises utilizing a second computer to access the first computer and navigate a path of the hierarchical structure of screens to a selected screen of the on-line tax preparation application. The method further comprises transmitting a request to bookmark the selected screen from the second computer through a first network to the first computer, and receiving a URL bookmark at the second computer from the first computer. With embodiments, the selected screen can be accessed directly with the URL bookmark without requiring the user to retrace navigation through prior screens along the path to the selected screen.

Yet another embodiment is directed to a computer-implemented method for generating a bookmark of a section, screen or page of an on-line tax preparation application operable to prepare an electronic tax return and comprises receiving, at a first computer hosting the on-line tax preparation application through a first network and from a second computer of the user of the on-line tax preparation application, a request for a URL bookmark of a selected screen following navigation of a path of a hierarchical structure of screens to the selected screen by a user of the on-line tax preparation application. The method further comprises determining context data associated with the selected screen. Context data identifies the screen and the path to the location of the selected screen or definition thereof within the hierarchical structure. According to embodiments, in response to the request, a URL bookmark based at least in part upon the determined context data is dynamically generated and transmitted from the first computer to the second computer. With embodiments, the selected screen can be accessed by the user clicking a URL bookmark in the form of a link embodying an URL address or entering or copying and pasting the URL address from within a second application other than the on-line tax preparation application and without the user retracing navigation through prior screens along the path to the selected screen.

A further embodiment is directed to a computer-implemented method for generating a bookmark of a section, screen or page of an AJAX application such as an on-line tax preparation application, one example of which is an on-line version of TURBO TAX, available from Intuit Inc., Mountain View, Calif. TURBO TAX is a registered trademark of Intuit Inc.

The method comprises determining context data associated with a selected screen of the AJAX application, such as a screen currently displayed. Context data identifies the screen and a path to a location of the selected screen or definition thereof within a hierarchical data structure of a plurality of screens. The method further comprises generating a URL bookmark based at least in part upon the context data such that a user of the AJAX application can access the selected screen directly with the URL bookmark without retracing navigation through prior screens along the path to the selected screen.

Another embodiment is directed to a computer-implemented method for bookmarking a section, screen or page of an AJAX application hosted by a first computer, one example of which is TURBO TAX on-line, available from Intuit Inc. The method comprises utilizing a second computer to access the first computer and navigate a first path of the hierarchical structure of screens to a selected screen of the AJAX application, and transmitting a request to bookmark the selected screen from the second computer through a first network to the first computer. The method further comprises receiving a URL bookmark at the second computer from the first computer. With embodiments, a user can use the URL bookmark, e.g., in the form of a link embodying a URL address, to access the selected screen directly without retracing navigation through prior screens along the path to the selected screen.

Yet another embodiment is directed to a computer-implemented method for generating a bookmark of a section, screen or page of an AJAX application, one example of which is TURBO TAX on-line, available from Intuit Inc. The method comprises receiving, at a first computer hosting the AJAX application through a first network and from a second computer of the user of the AJAX application, a request for a URL bookmark of a selected screen following navigation of a path of a hierarchical structure of screens to the selected screen by a user of the AJAX application. The method further comprises determining context data associated with the selected screen, the context data identifying the path to the location of the selected screen or definition thereof within the hierarchical structure. With embodiments, a URL bookmark is dynamically generated based at least in part upon the determined context data and transmitted from the first computer to the second computer in response to the first request. In this manner, the selected screen can be accessed by a user of the AJAX application by entering or copying and pasting the URL bookmark in the form of a URL address or clicking a link embodying the URL address from within a second application other than the AJAX application and without retracing navigation through prior screens along the path to the selected screen.

Further embodiments are directed to computer programs or computer program products that provide for bookmarking a specific or selected section, screen or page within an AJAX application, such as an on-line tax preparation application, which may be hosted by a server that can be accessed by multiple users who prepare respective electronic tax returns. According to embodiments, computer program products comprise a non-transitory computer readable storage medium embodying one or more instructions executable by a computer to perform process embodiments for bookmarking a screen of an AJAX application by requesting a URL bookmark from a client side or generating a URL bookmark on a server side. Embodiments may be integrated into or a part or module of the AJAX application or separate programs that operate with the AJAX application.

Other embodiments are directed to systems for bookmarking a section, screen or page of an AJAX application, such as an on-line tax preparation application utilized to prepare an electronic tax return such that a specific or selected section, screen or page of the electronic tax return can be bookmarked. A system constructed according to one embodiment comprises or involves a first computer hosting an AJAX application such as a tax preparation application that presents a series of interview screens to a user via a single URL address. The system further comprises a URL bookmark program or web controller, which may be integrated into the AJAX or on-line tax preparation application program or a separate program. The host computer is operably coupled to or in communication with a computer of a user via a network. In certain system embodiments, the user is a technical support person assisting an end user of the AJAX application in which case the technical support person may request a URL bookmark, e.g. in the form of a URL address or link generated by the URL bookmark program or controller, returned to the technical support person, who may then provide the URL bookmark to another computer such that the end user can receive or access the URL bookmark in the form of an electronic mail message or a link posted to a website. In other system embodiments, the user is the end user who clicks on a link to jump to the bookmarked screen, and the URL bookmark program generates a view of the requested screen without requiring the end user to navigate through other screens. In embodiments in which the AJAX application is a tax preparation application, the host computer may also serve as an electronic filing server that formats or processes electronic tax returns for filing with a tax authority computer.

According to one or multiple system embodiments, the bookmark program or on-line tax preparation application if so programmed is configured receive a request from a user to bookmark a particular section of an electronic tax return by bookmarking a specific screen or location within the plurality of interview screens of the on-line tax preparation application. The request may, for example, be transmitted from the user computer to the host computer in response to the user executing a widget to indicate that a URL bookmark is to be generated for a selected or currently displayed screen. The request is received at the host computer, a URL bookmark is generated using the URL bookmark program or web controller based at least in part upon context data of the screen that is the subject of the request. The URL bookmark is sent to the user and can later be selected or clicked to jump to the bookmarked screen at a later time without navigating through the path that was required to initially reach the bookmarked screen.

In a single or multiple embodiments, an AJAX application such as an on-line tax preparation application such as TURBO TAX is accessed through a browser executing on the first or user computer. The AJAX application includes multiple pages or screens that are displayed to the user with a single URL address of the browser. In other words, the screens or pages of the AJAX application are navigated using the same web page address such that the different pages or screens of the AJAX application do not have their own unique URL addresses. However, with embodiments, URL addresses are generated for respective screens based at least in part upon their context data, which identifies a path to a particular screen within a hierarchical or tree structure of a plurality of screens or definitions thereof.

In a single or multiple embodiments, the selected screen being accessible by the user from within an application other than the on-line tax preparation application, and the different application may execute on the same or different computers of the same or different users. For example, the other application may be an electronic mail application for accessing or reading an electronic mail message including the URL bookmark or a browser for accessing a website to which the URL bookmark was posted, e.g., in the form of a link. In the case of a user clicking a link, the resulting or constructed URL address is read, and the URL bookmark program determines context data of the URL address and generates a view of the corresponding screen. Thus, clicking, entering or pasting the URL bookmark from within a different application provides for direct access to a screen of the AJAX application without retracing the path to the screen.

In a single or multiple embodiments, the user is an end user of the AJAX application or a technical support person assisting the end user, e.g., a technical support person assisting with preparation of an electronic tax return. If a technical support person is involved, the technical support person may request that a URL bookmark be generated, send the URL bookmark to the end user who may then use the URL bookmark at a later time and independently of the technical support person.

In a single or multiple embodiments, URL bookmarks are dynamically generated or generated on-the-fly in real time in response to a user request. Thus, for example, if a technical support person wants to generate a URL bookmark for an end user, the technical support person may navigate screens to a desired or selected screen, execute a widget or other user interface element to request the URL bookmark for the screen, the URL bookmark is generated and transmitted back to the technical support person computer who then may send the URL bookmark, e.g., in the form of a link embodying a URL address including associated context data, to the end user. When the end user later clicks the link, a request is sent from the end user computer to the host computer, the URL bookmark program determines the context data of the URL address within the URL bookmark, navigates the path to the selected screen using a state machine, and generates a view of the selected screen in response to the second request, the view being displayed to the end user. Thus, the end user is taken directly to the requested screen and is not required to navigate a pre-determined sequence of multiple screens to arrive at the desired screen of the URL bookmark.

After the user has completed the electronic tax return, using one, two, three or other numbers of URL bookmarks in the form of links and/or URL addresses as needed, the electronic tax return is processed by the host computer if configured to also serve as an electronic filing server, or a separate electronic filing server can be utilized. The electronic filing server transmits the completed electronic tax return to a computer of a tax authority.

Thus, embodiments implement URL bookmarks within an AJAX application such as a tax preparation application that functions by displaying multiple pages with a single URL address, and does so independently of navigation and bookmarking mechanisms of a browser utilized to access the on-line tax preparation application and without performing URL hashing, as is done in certain known methods and systems.

### BRIEF DESCRIPTION OF THE DRAWINGS

These and other aspects of embodiments are described in further detail with reference to the accompanying drawings, wherein:

FIG. 1A is a block diagram of a system constructed according to one embodiment for generating URL bookmarks in the form of URL addresses or links embodying URL addresses of pages or screens of an AJAX application such as an on-line tax preparation application, and FIG. 1B illustrates a database constructed according to one embodiment for storing data of generated URL bookmarks and screens of an AJAX application;

FIG. 2 is a flow diagram illustrating one embodiment of a method for requesting and generating a URL bookmark of a screen or page of an AJAX application such as a tax preparation application;

FIG. 3 generally illustrates how AJAX application such as an on-line tax preparation application are configured to display multiples pages or screens while a URL address within a browser remains unchanged;

FIG. 4 generally illustrates how interview screens of an AJAX application such as an on-line tax preparation application are organized in a hierarchical or tree structure such that a desired screen is reached by following a path of the hierarchical or tree structure;

FIG. 5 is a flow diagram illustrating one embodiment of a method for directly navigating to a screen or page of an AJAX application such as a tax preparation application bookmarked with a URL address or link accessible from an application other than AJAX application or from outside of the AJAX application;

FIG. 6A is a block diagram of a system constructed according to one embodiment involving an end user and a host computer including a program or application for bookmarking and directly navigating to a specific screen of an on-line tax preparation application that is operable to prepare and file an electronic tax return with a URL address or link accessible from an application other than on-line tax preparation application or from outside of the on-line tax preparation application, and FIG. 6B is a block diagram of a system constructed according to another embodiment in which a technical support person assists an end user of an on-line tax preparation application;

FIG. 7 generally illustrates how interview screens of on-line tax preparation application are organized in a hierarchical or tree structure based on different tax-related topics such as personal information, income and deductions;

FIG. 8 is a flow chart of one embodiment of a method for navigating to a specific screen of an on-line tax preparation application and generating a bookmark in the form of a URL address;

FIG. 9 is a flow chart of one embodiment of a method for entering a URL address or clicking a link embodying the URL address to navigate directly to the specific screen bookmarked with the URL address or link that is accessible from an application other than on-line tax preparation application or from outside of the on-line tax preparation application;

FIGS. 10A-E illustrate examples of how embodiments may be implemented, FIGS. 10A-C illustrating one embodiment in which a user such as a technical support person may navigate to a screen and generated a URL bookmark of the screen and provide the URL bookmark to an end user, FIGS. 10D-E illustrating one embodiment in which an end user accesses a website to click on a link embodying the URL bookmark to navigate directly to the bookmarked screen; and

FIG. 11 is a system diagram of components of a computing apparatus that may be utilized by various system components.

### DETAILED DESCRIPTION OF ILLUSTRATED EMBODIMENTS

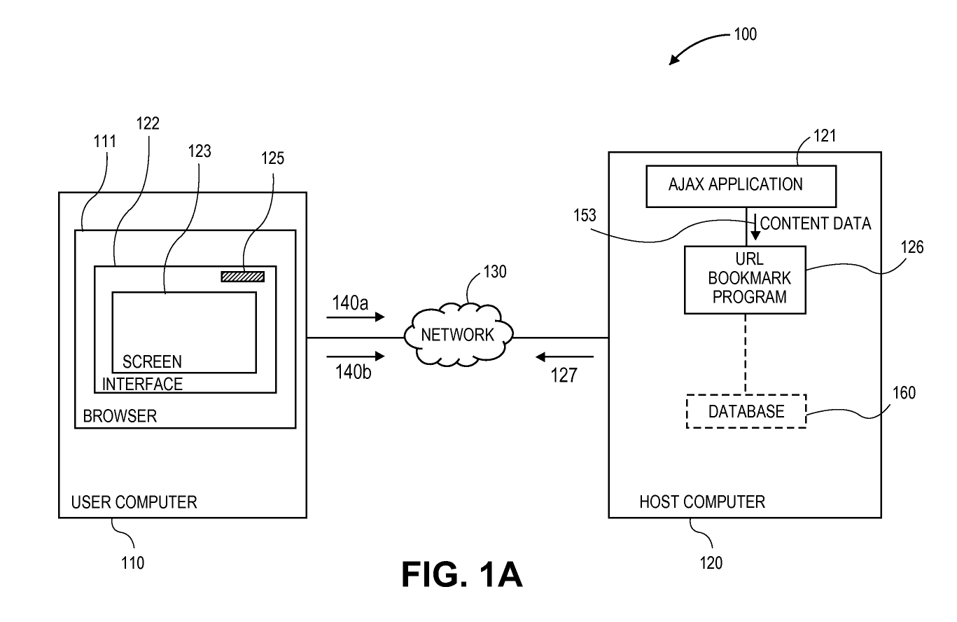

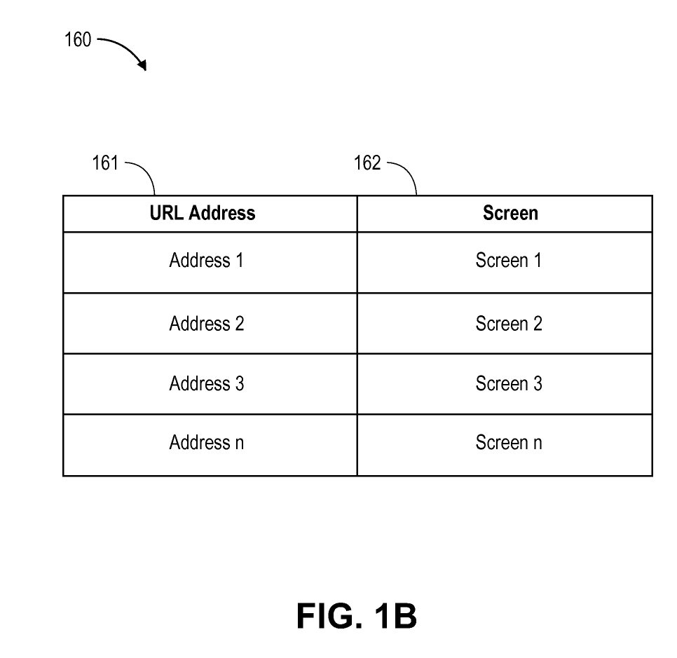

Embodiments relate to generating and navigating to bookmarks within an application that presents multiple screens or pages within a browser using a single Uniform Resource Locator (URL) address, e.g., within an Asynchronous JavaScript and XML (AJAX) application. In one embodiment, bookmark functionality is provided such that a user of a first application or program, such as a web browser, electronic mail program or other application or program besides the on-line tax preparation application, can be used to navigate directly to a specific page or screen of an AJAX application such as an on-line tax preparation application that is operable to prepare and electronically file an electronic tax return. With embodiments, a bookmark in the form of a URL address or link embodiment the URL address can be dynamically generated and provided to an end user who may then click on the link at a later time to jump to or navigate directly to the bookmarked screen without navigating through any prior or intervening screens. These bookmarking and navigation capabilities are independent of browser bookmarking mechanisms and are performed without URL hashing. Embodiments and aspects thereof are described in further detail with reference to FIGS. 1A-11.

Referring to FIGS. 1A-3, a system 100 and method 200 for generating URL bookmarks within an AJAX application 121 includes or involves a user computer 110 and a host computer 120. An AJAX application 121 executes on host computer 120 or on another computer (not shown in FIG. 1) that is accessible by host computer 120. A browser 111 executes on user computer 110 and is utilized to access AJAX application 121 through a network 130, and AJAX application user interface (UI) 122 is displayed on user computer 110 through browser 111.

Network 130a and other networks discussed herein (generally, network 130) utilized for communications between system components may involve, for example, cellular, wireless and Internet communications involving a Local Area Network (LAN), a Wide Area Network (WAN), Metropolitan Area Network (MAN), a wireless network, other suitable networks capable of transmitting data, or a combination of such networks and different communication methods or protocols. For ease of explanation, reference is made generally to network 130.

According to one embodiment, method 200 involves user, which may be an end user, technical support person, or other user, navigating screens or pages 123 (generally, screens 123) of AJAX application 121 to a specific or selected screen 123 at 202. Depending on the user and data input status, screens 123 may be blank and include no data or screens 123 may include associated data 124, which may be data that was entered by user, imported into fields of screen 123, and/or a result of a calculation or other processing of data 124 performed by AJAX application 121.

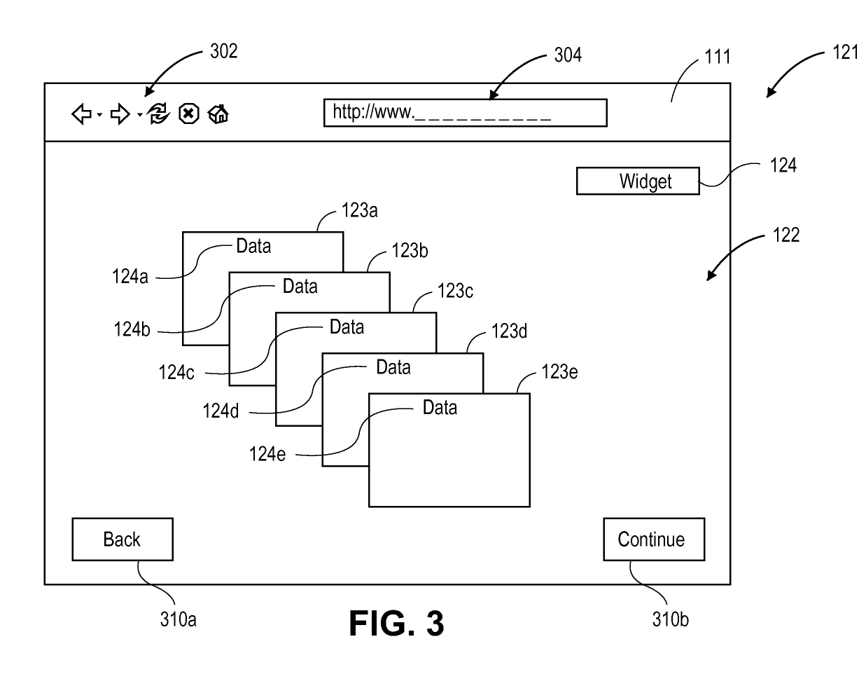

For example, as generally illustrated in FIG. 3, browser 111 may include browser navigation buttons 302 (e.g., back, forward, refresh, stop, home) and display a URL address 304. UI 122 of AJAX application 121 is displayed within a view of browser 111. If so configured, AJAX application 121 may be navigated by user utilizing navigation buttons 310a (“back”) and 310b (“continue” or forward) to display prior and next screens 123 while URL address 304 of browser 111 remains the same. Multiple screens 123 can be viewed and navigated by user, and while FIG. 3 illustrates five screens 123a-e and associated screen data 124a-e (which may or may not be present), it will be understood that a single screen 123 or multiple screens 123 may be displayed at a given time depending on how AJAX application 121 is configured. Thus, FIG. 3 is intended to generally illustrate sequential screens 123 of AJAX application 121, screens 123 may include associated data 124, and each screen 123 is displayed within browser 111 with a single URL address 304 that remains the same as user navigates through screens 123.

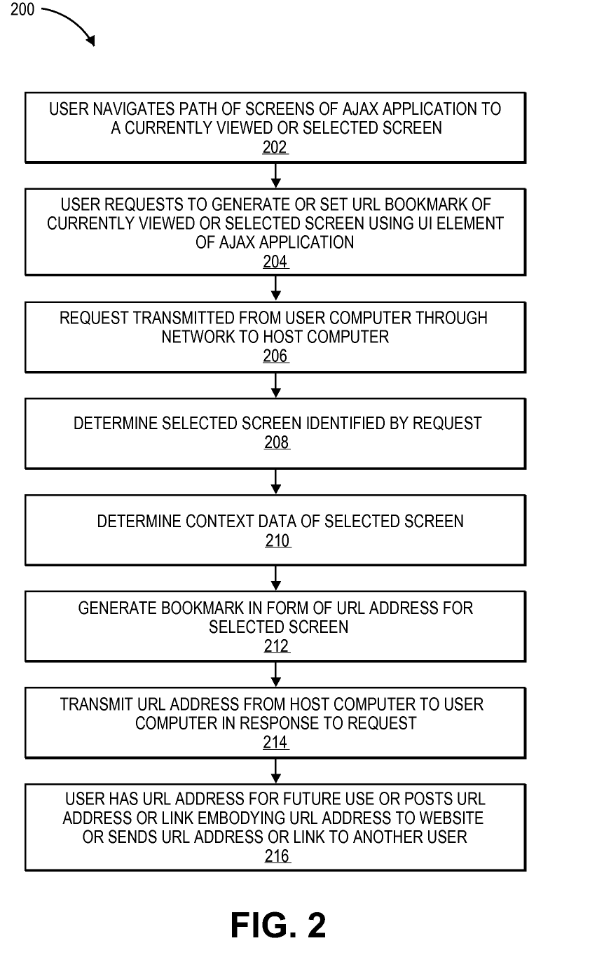

Referring again to FIG. 2, at 204, while viewing screen 123, user requests to generate or set a URL bookmark of that screen 123 or screen location with a UI element 125 of AJAX application UI 122 (as opposed to navigation element 302 or bookmarking mechanism of browser 111). At 206, a request 140a to generate or set a URL bookmark 127, e.g. an AJAX or other suitable request, is transmitted from user computer 110 to host computer 120 via network 130.

At 208, request 140a is received by a URL bookmark program 126 of, or associated with, AJAX application 121, and URL bookmark program 126 determines which screen 123 is the subject of request 140a. While FIG. 1A illustrates a separate URL bookmark program 126, it should be understood that URL bookmark program 126 may be a separate program (as illustrated) or embodied within or a program or module of AJAX application 121. For ease of explanation, reference is made to a separate bookmark program 126.

With continuing reference to FIGS. 1A and 2, bookmark program 126, at 210, determines context data 153 of screen 123 or screen 123 location to be bookmarked per request 140a, and dynamically generates URL bookmark 127 in the form of a URL address or a link embodying URL address based at least in part upon determined context data 153 at 212. A “URL bookmark” 127 is defined as including a URL address for a specific screen 123 and a hyperlink, hypertext link or web link (generally, “link”) embodying URL address, and it will be understood that embodiments may be implemented with both URL addresses and links, both of which involve or include a URL address. While embodiments may involve a URL address or link, reference is made to URL bookmark 127 or a link embodying the URL address for ease of explanation.

At 212, URL bookmark program 126 transmits generated URL bookmark 127 from host computer 120 to user computer 110 in response to request 140a. URL bookmark 127 is transmitted to user or another computer accessible by user by, for example, posting link 127 to a website (such as a social network website or technical support website) or including link 127 in an electronic mail (e-mail) message, text or SMS message or other form of electronic or wireless communication. As such, at 216, user has link 127 for future use.

According to one embodiment, link 127 is dynamically generated or generated in real-time in response to request 140a. According to another embodiment, as generally illustrated by dotted line in FIG. 1A and in FIG. 1B, as links 127 are dynamically generated, links or corresponding URL addresses may be stored in a database 160 with columns 161 and 162 for URL addresses for respective screens 123. Database 160 may be generated before implementation of embodiments or updated in real-time as links are dynamically generated by URL bookmark program 126. In other words, certain embodiments may involve URL bookmark program 126 accessing and searching database 160 to determine which URL address should be utilized to bookmark a particular screen 123. Further, according to one embodiment, URL bookmark 127 that is generated for a particular screen 123 is the same URL bookmark 127 that is utilized for the same screen 123 accessed by multiple or other users such that database 160 entries for a particular URL bookmark 127 may apply to multiple users. For ease of explanation, reference is made to URL bookmarks 127 that are dynamically generated, but it should be understood that database 160 may be utilized to determine URL bookmarks 127 and/or store related data before or as URL bookmarks 127 are generated.

In embodiments, depending on how the URL bookmark 127 is defined or structured, data of URL bookmark 127 may include one or multiple types of data including one or more or all of data indicating a source of request 140a (e.g. source may be a virtual webserver such as turbotaxweb.turbotaxonline.intuit.com to the TURBOTAX application in embodiments involving such applications, tests to run, context data 153 identifying screen 123 to be bookmarked or how screen 123 is located or identified, e.g., a path to screen 123 within a hierarchical, tree or node structure (generally, “tree structure”), and a version of AJAX application 121. With these types of context data 153, bookmarking screen 123 is defined as including bookmarking screen 123 itself or a location of screen 123 or definition thereof within a hierarchical or tree structure of screens 123.

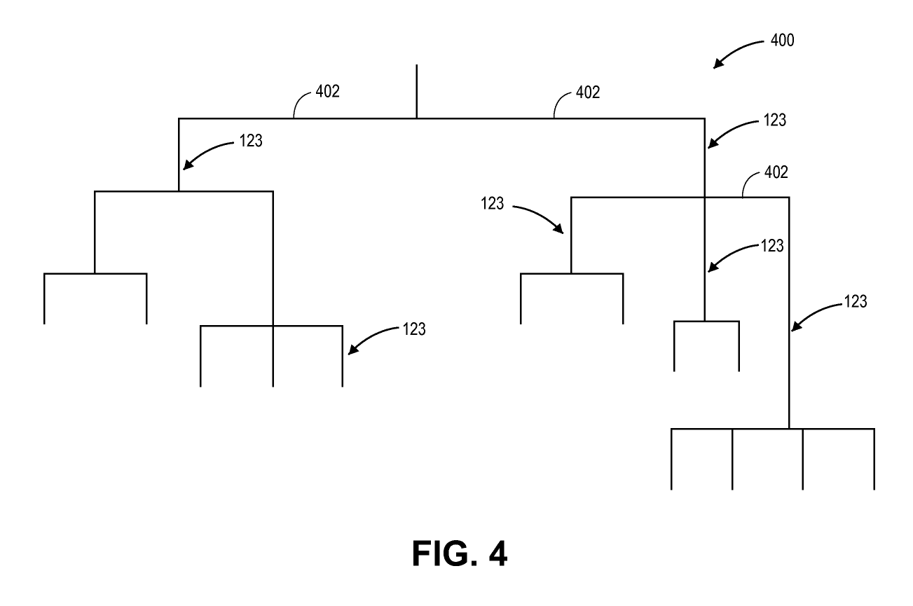

For example, as generally illustrated in FIG. 4, a tree structure 400 may include various branches 402 defining respective paths and sequences of screens 123 to a specific screen 123 to be presented to user depending on how user responds to certain questions presented within prior or current screens 123. As generally illustrated in FIG. 4, user may navigate various screens 123 of tree structure 400 and, for example, generate a first URL bookmark 127a for a first screen 123a that is accessible via a first path and a second URL bookmark 127b for a second screen 123b that is accessible via a second path, and so on for additional URL bookmarks 127n.

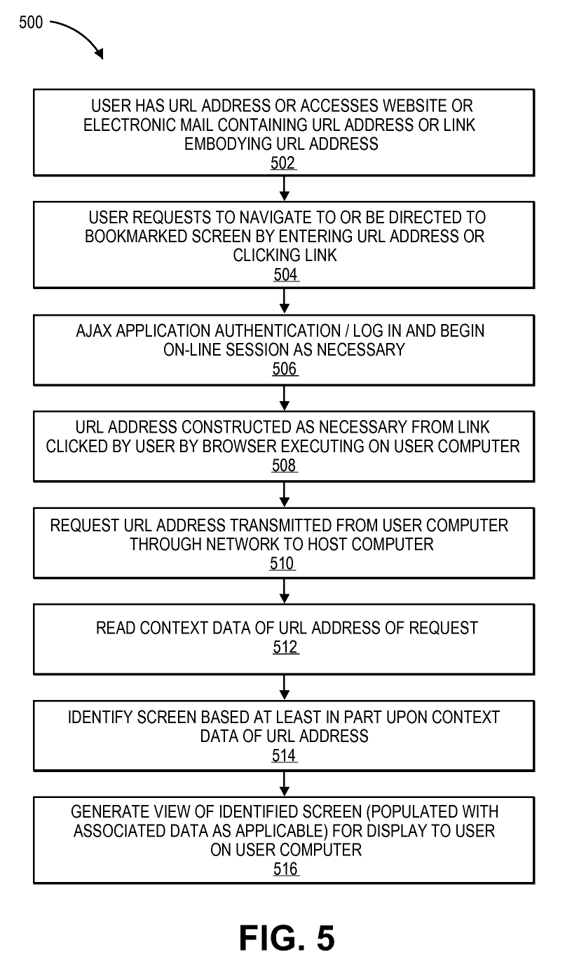

Referring to FIG. 5, at 502, user has generated URL bookmark 127 such as a link embodying a generated URL address. Link 127 may be posted to a website or transmitted to another user via e-mail or other form of communication. For example, link 127 may be posted to a technical support website for AJAX application 121 or to a social networking website that is accessible by various users such that one or multiple users can access the same screen 123 directly using the same link 127. Examples of social networking websites to which link 127 may be posted according to embodiments include, but are not limited to, FACEBOOK, MYSPACE, TWITTER, LINKEDIN, etc. Thus, according to embodiments, a URL bookmark 127 in the form of an actual URL address or link embodying URL address is provided within or transmitted or posted to an application or program other than AJAX application 121.

When user wishes to navigate directly or jump to bookmarked screen 123, during the same or different AJAX application 121 session, at 504, user may enter URL address (if provided to user) into address field 304 of browser 111 or another application besides AJAX application 121 or click on link 127 from within a website (such as a technical support or social networking website) or an e-mail message in order to navigate directly to the bookmarked screen 123. At 506, if necessary, user is authenticated, e.g., by logging into AJAX application 121 with user name, password or other authentication information to begin an on-line session of AJAX application 121.

At 508, if user clicks on link 127 embodying URL address, the URL address corresponding to link 127 is read by browser 111 executing on user computer 110, and at 510, request 140b, such as a HTTP request containing URL address, is transmitted by browser 111 from user computer 110 (which may be the same computer utilized to request URL bookmark 127 as shown in FIG. 1A or a different computer) through network 130 to host computer 120 and received by URL bookmark program 126.

At 512, URL bookmark program 126 reads context data 153 embodied within URL address and at 514, identifies requested screen 123 based at least in part upon context data 153. At 516, URL bookmark program 126 generates a view of identified screen which, according to certain embodiments, may also be populated and displayed with associated data if bookmark program 126 has access to previously entered data associated with the specific bookmarked screen 123.

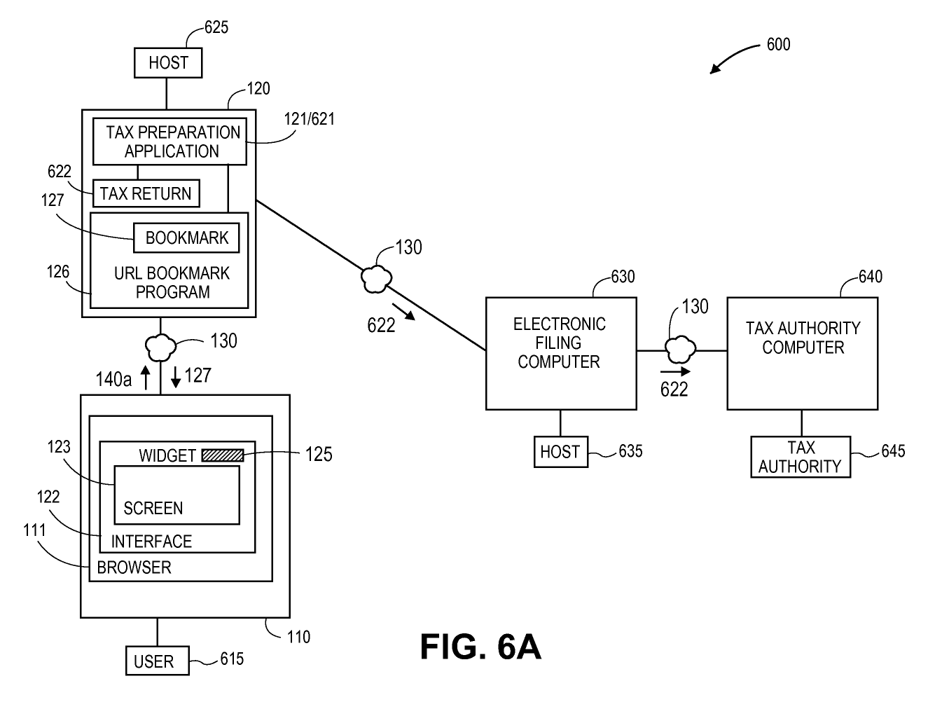

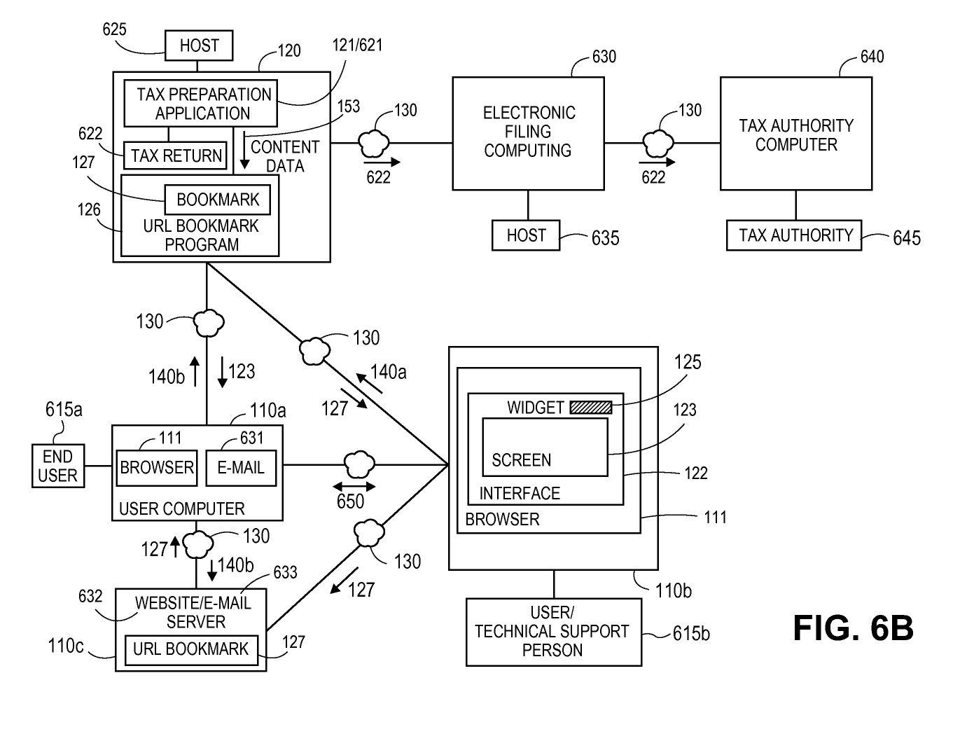

Thus, FIGS. 1A-5 illustrate how embodiments provide for bookmarking screens 123 of AJAX application 121 using a URL bookmark 127 in the form of a URL address or link embodying the URL address, without using a bookmark mechanism of the browser 111 or URL hashing as is done in various known systems and methods. With embodiments, URL bookmark 127 that includes context data 153 can be used to generate and navigate to specific screens 123 at different levels of a tree or hierarchical structure 400 of screens 123 by use of UI element 125 and requests 140a,b made to host computer 120, in response to which URL bookmark program 126 dynamically generates links 127 embodying respective URL addresses and sends respective links 127 to user via an e-mail or by posting link 127 to a website such that when link 127 is subsequently selected by the same or other user, URL bookmark program 126 generates a view of bookmarked screen 123 to that user. One manner in which embodiments may be implemented is described in further detail with reference to FIGS. 6A-10E, which relate to embodiments for generating and navigating URL bookmarks 126 for screens 123 of an AJAX application in the form of an on-line tax preparation application utilized to prepare and file an electronic tax return.

Referring to FIG. 6A, one embodiment is directed to a system 600 for generating URL bookmarks 127 and using URL bookmarks 127 to navigate within an on-line tax preparation application 621 that executes on computer 120 that is managed by a host 625. On-line tax preparation application 621 may be on-line version of TURBO TAX available from Intuit Inc., Mountain View, Calif., H&R BLOCK TAX CUT and TAXACT available from H&R Block, Inc., Kansas City, Mo. TURBO TAX is a registered trademark of Intuit Inc. Host 625 may be a source of on-line tax preparation application 621 or host of computer 120, such as Intuit Inc. and other hosts of other tax preparation applications 621. For ease of explanation, reference is made to on-line tax preparation application 621, one example of which is TURBO TAX, although it will be understood that embodiments may be implemented in other on-line tax preparation applications 621 and other AJAX applications 121.

In the embodiment illustrated in FIG. 6A, on-line tax preparation application 621 is utilized by user 615a who may, in certain embodiments, be an end user such as a preparer of an electronic tax return 622. Such end users 615a may be an individual tax payer, an accountant or other tax professional (generally, “end user”), who uses on-line tax preparation application 621 to prepare and electronically file electronic tax return 622. Thus, in the illustrated embodiment, communications between the end user computer 110 and host computer 120 are direct via network 130, and end user 615 requests URL bookmark 127 from host computer 120

Referring to FIG. 6B, in another embodiment, end user 615a may utilize user computer 110a and browser 111 to access on-line tax preparation application 621 to prepare an electronic tax return 622, and end user computer 110a may be involved in communications with one or more additional computers such as technical support person computer 615b and another computer 615c that hosts a website 632 or is an e-mail server 633 to which technical support person may provide URL bookmarks 127 that can be subsequently accessed or downloaded (represented by arrow between end user computer 110a and computer 110c) by end user 615 and possibly other users.

Thus, FIG. 6A illustrates an embodiment in which end user 615 communicates directly with URL bookmark program 126, and FIG. 6B illustrates an embodiment in which a user such as a technical support person 615 interfaces with URL bookmark program 126 and provides assistance or URL bookmarks 127 directly to user computer 110a or indirectly via another computer 110c that hosts a website 632 or is an e-mail server 633 that is accessible by end user 615a executing browser 111 or an e-mail program 631 such as MICROSOFT OUTLOOK on end user computer 110.

During preparation of the electronic tax return 622, end user 615a may require assistance of another user 615b such as a technical support person of host 625 who provides assistance to end users 615a with support computer 110b. For example, end user 615a may contact technical support person 615b (illustrated by arrow 650) to identify screen 123 that must be completed for a particular tax situation. Reference is made to a user 110 generally or more specifically to end user 110a and technical support person 110b.

End user computer 110a and technical support person computer 110b are operably coupled to or in communication with the host computer 120 via respective networks 130. End user computer 110a and technical support person computer 110b may be a home or office computer or a mobile communication device such as a cellular telephone, a PDA such as a BLACKBERRY, a Smartphone, an IPHONE available from Apple Inc., and other mobile computing or communications device capable of wireless communication with host computer 120.

If host computer 120 is not also an electronic filing server, then as shown in FIGS. 6A-B, host computer 120 is operably coupled to an electronic filing system or server 630 via network 130. Electronic filing server 630 is operably coupled to or in communication with a computer 640 of a tax authority 645 such as the Internal Revenue Service, a state tax authority or other tax collecting entity (generally, “tax authority”). Electronic filing system or server 630 may serve as a “clearing house” for electronic tax return 622 that is ready to be transmitted to tax authority 645 and to process acknowledgements and other data received from tax authority 645 and to route related information back to end user 615a. One example of electronic filing server 630 is a server of Intuit Inc., e.g., a server of the Intuit Electronic Filing Center. Other examples of electronic filing servers 630 include electronic filing servers utilized by other tax return preparation applications 621.

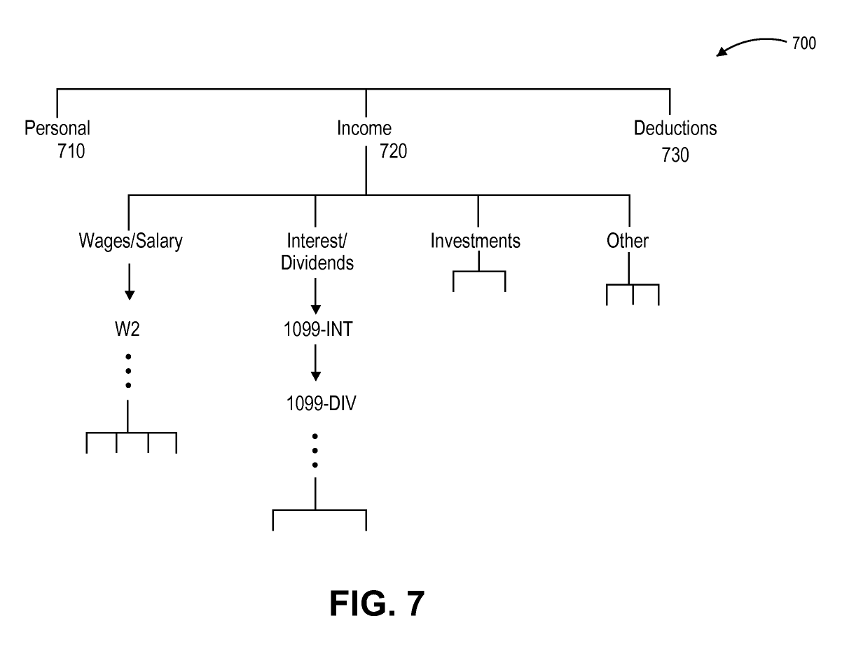

During use of on-line tax preparation application 621, a series of tax-related interview screens 123 with questions or data entry fields is presented to end user 615a. As generally illustrated in FIG. 7, interview screens 123 may be organized in a hierarchical or tree or node structure 700 which, in the illustrated embodiment, includes branches or nodes of that are part of pre-determined sequences of interview screens 123 for different tax-related topics such as personal information 710, income 720 and deductions 730.

For example, certain interview screens 123 or questions in sequence of screens for “Personal Information” 710 may relate to personal and family matters such as the user's social security number, marital status, number of dependents, etc. Interview screens and questions in the “Income” 720 branch may relate the user's finances such as wages, retirement plan contributions, and social security income, whereas other interview screens, and interview screens 123 and questions in the “Deductions” branch 730 may relate to state and federal taxes that were paid or withheld as provided in Form-W2. The particular structure or paths employed may be selected by host 625 and/or dictated in part by tax requirements or by tax authority 645.

For example, paths along “income” 820, may present a sequence of interview screens 123 related to wages and salary, interest and dividends, investment income and other types of income. End user 615a enters various tax-related data while following the path or pre-determined sequence of interview screens 123 for each topic and/or based on end user 615a input or responses to questions. This is done for each relevant topic, and upon completing interview screens 123 along one path (e.g., upon completing “personal information” 810), on-line tax preparation application 621 may begin again at a parent branch or node for a new topic (e.g., “Income” 820) such that a sequence of interview screens 123 related to the next topic is then presented to end user 615a until electronic tax return 622 is completed.

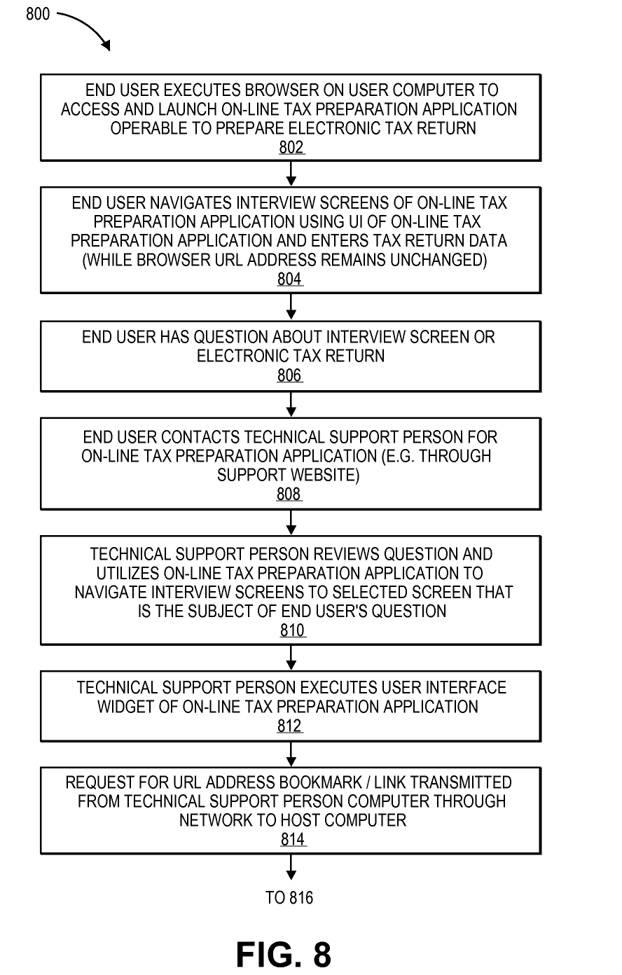

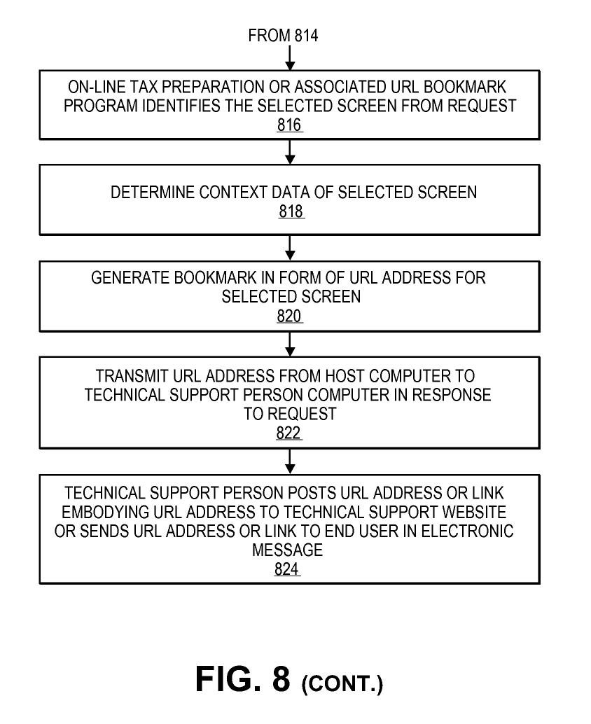

Referring to FIG. 8, one embodiment of a method 800 for generating a URL bookmark 127 for a specific screen 123 involves system configuration shown in FIG. 6B in which a technical support person 615b assists end user 615a, but it will be understood that other system configurations may involve the same user or same computer rather than multiple users and multiple computers.

At 802, end user 615a executes browser 111 to access and launch on-line tax preparation application 621 executing on host computer 120 to prepare electronic tax return 622. At 804, end user 615a navigates interview screens 123 of on-line tax preparation application 621 and enters tax return data, which may be personal data, income data, deduction data, etc., as appropriate. With TURBOTAX as an example, end user 615a navigates various screens 123 while URL address 304 of browser 111 remains the same. Thus, while not specifically illustrated, end user 615a utilizes browser 111 and tax preparation application interface 122 to view screens 123.

At 806, for various reasons, end user 615a has a question about an interview screen 123 or part of electronic tax return 622. For example, the question may involve screen 123 that end user 615a cannot locate or end user 615a is not certain which screen 123 applies to a particular tax situation or question. Thus, at 808, end user 615a contacts 650 technical support person 615b, e.g., through a support website hosted by technical support person computer 110b or another associated computer. For example, in the case of TURBO TAX, technical support person 615b may be a member of LIVE COMMUNITY which is on-line technical support site in which technical support persons e-mail or chat with end users.

At 810, as part of researching the issues presented by end user 615a, technical support person 615b utilizes on-line tax preparation application 621 to navigate screens 623 of the hierarchical structure along a path to a current or selected screen 623 that is the subject of end user's question. At 812, according to embodiments, technical support person 615b selects or executes an element 125 of the UI 122 of on-line tax preparation application 621. UI element 125 may, for example, be a widget (e.g., a JavaScript widget) or other UI elements such as a toolbar element, button or menu item that is displayed by on-line tax preparation application 621 and that can be utilized independently of navigation 302 and bookmark mechanisms of browser 111. For ease of explanation, reference is made to widget 125, which can be installed within or accessible through UI 122 of on-line tax preparation application 621.

At 814, a request 140a is made for URL bookmark 127 in the form of a URL address or link embodying the URL address of the current or selected screen 123 to which technical support person 615b navigated. In the embodiment illustrated in FIG. 6B, request 140a is transmitted from technical support person computer 110b through network 130 to host computer 120. At 816, on-line tax preparation program 621 or associated URL bookmark program 126 identifies screen 123 that is the subject of URL bookmark request 140a, and at 818, determines context data 153 of selected screen 123.

According to embodiments, context data 153 is defined herein as data identifying interview screen 123 (e.g., by screen tag, label or other identifier) to be bookmarked according to embodiments and the path to screen 123 within hierarchical or tree structure of a plurality of screens 123. Thus, as “screen” or “interview screen” or “page” is defined to include actual screens and definitions or representations thereof. State data, on the other hand, is data 124 within an interview screen 123, e.g., data 124 that was entered by the user 715, imported into the screen 123 or a result of a calculation performed by the on-line tax preparation application 720.

At 820, URL bookmark program 126 generates a URL bookmark 127 in the form of a URL address or link for selected screen 123 and embodying context data 153 that identifies screen 123 and a path to screen 123 within hierarchical structure of screens 123. URL bookmark 127 may include or be defined or expressed in terms of context data 153 identifying the screen 123 being bookmarked, context data 153 identifying a path to the screen 123 and, in certain embodiments, state data including data 124 within the screen 123 at the time widget 125 was executed by technical support person 615b.

Thus, in one embodiment, URL bookmark 127 allows a user to jump to an unpopulated screen 123. In other embodiments, URL bookmark 127 allows a user to jump to screen 123 that is populated with state data. For this purpose, URL bookmark 127 may bookmark a screen 123 with associated state data stored in a database or other data structure if URL bookmark program 126 is aware that end user 615a is a user of on-line tax preparation application 621 and has previously filed or is currently preparing an electronic tax return 622 using on-line tax preparation application 621. Thus, with embodiments, URL bookmark 127 to screen 123 or screen location in the form of a URL address or link is generated without utilizing browser 111 navigation or browser 111 bookmark mechanisms and without performing URL hashing as in known systems.

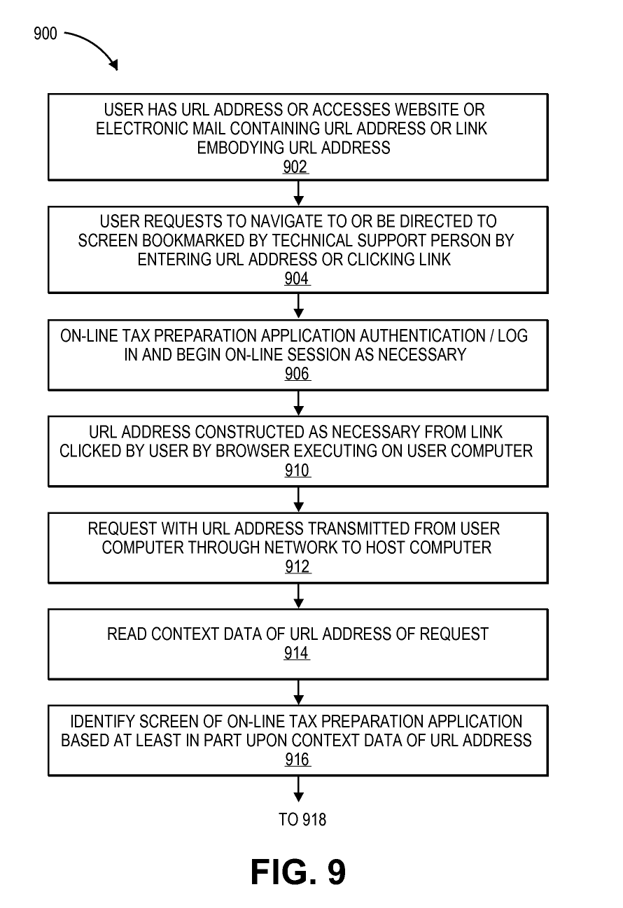

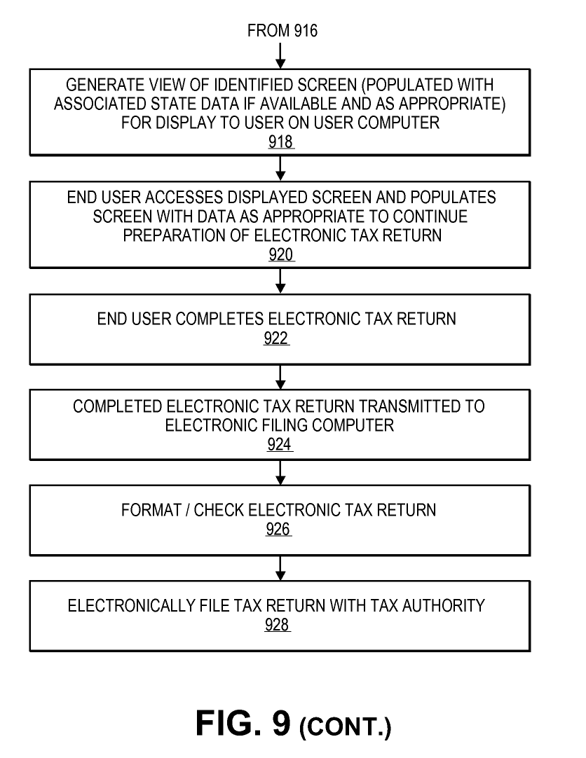

Referring to FIG. 9, with technical support person 615b requesting a bookmark and URL bookmark 127 being generated and transmitted to or accessible by end user 615a, at 902, end user 615a has or can access URL bookmark 127, e.g., through computer 110c that hosts a website 632 or serves as or includes an e-mail server 633. At 904, end user 615a enters the URL address (if provided) into browser 111, launches browser 111 to access a website 632 and clicks on the URL bookmark link within website 632, or opens an e-mail message 631 and clicks on the link, to request to navigate to or be directed to the screen 123.

End user's request 140b may be submitted when end user 615a continues preparation of electronic tax return 622 or decides to jump to screen 123 that was the subject of the end user's prior question presented to technical support person 615b. End user request 140b may be on the same day or at a later time such as the following day or a week, month or other time thereafter. Whenever end user request 140b is submitted, if not already logged into the on-line tax preparation application 621, at 906, end user 615a may be required to log into on-line tax preparation application 621 and satisfy other authentication requirements as necessary.

At 908, if the URL address was not separately entered or copied and pasted into a browser address bar, the URL address is read by browser 111 based upon link clicked by end user 615a. At 910, a navigation request 140b with the URL address is transmitted from end user computer 110a through network 130 to host computer 120, and at 912, URL bookmark program 126 receives navigation request 140b and reads context data 153 of the URL address of navigation request 140b.

At 914, URL bookmark program 126 identifies screen 123 of on-line tax preparation application 621 to which end user 615a desires to navigate based at least in part upon context data 153 of URL address, and at 916, generates a view of identified screen 123. As mentioned above, the view may include screen 123 without any data or, if URL bookmark program 126 is configured to access state data, the view may include the requested screen 123 populated with any available state data. At 918, end user 615a is presented with the requested screen 123.

For this purpose, for example, URL bookmark program 126 may determine the identity of the screen 127 and advance a state machine of or associated with the tax preparation application 621 to the location of the screen 123 along the path of the tree structure of the plurality of screens 123 based on the received context data 153. This generated screen or view is then displayed to end user 615a, who may then use navigation controls of tax preparation application 621 (such as “back” and “continue”) to navigate from bookmarked screen 123. Thus, with embodiments, end user 615a is able to navigate or jump directly to the requested screen 123 using a link 127 provided by someone else, without navigating through any prior or intervening screens 123.

End user 615a eventually continues preparation of electronic tax return 622, and at 920, electronic tax return 622 is completed and transmitted to an electronic filing computer 630. Host computer 620 may serve as electronic filing server 630 or a separate computer may be utilized for this purpose. At 924, electronic tax return 622 is checked and formatted as necessary and electronically filed with computer 640 of tax authority 645 at 926.

Thus, with embodiments, a URL bookmark 127 can be generated to identify a location of a screen 123 or definition thereof within a hierarchical or tree structure of screens 123 or definitions thereof using a widget 125, and the resulting URL bookmark 127, whether a link or URL address, can be entered or selected to navigate directly to the bookmarked screen 123 without navigating any prior or intervening screens. Further, if bookmark program 123 is configured to communicate with on-line tax preparation application 621 and a source of state data, the bookmarked screen can also be displayed with corresponding state date such that end user 615a can jump to various bookmarked screens, each of which may include corresponding state data if available.

Embodiments may be configured to generate URL bookmarks 127 dynamically or in real time. In another embodiment, URL bookmarks 127 in the form of pre-determined URL addresses or links are associated with respective screens 123 such that when a screen 123 is to be bookmarked, bookmark program 1236 can lookup URL address in a database to identify corresponding screen 123.

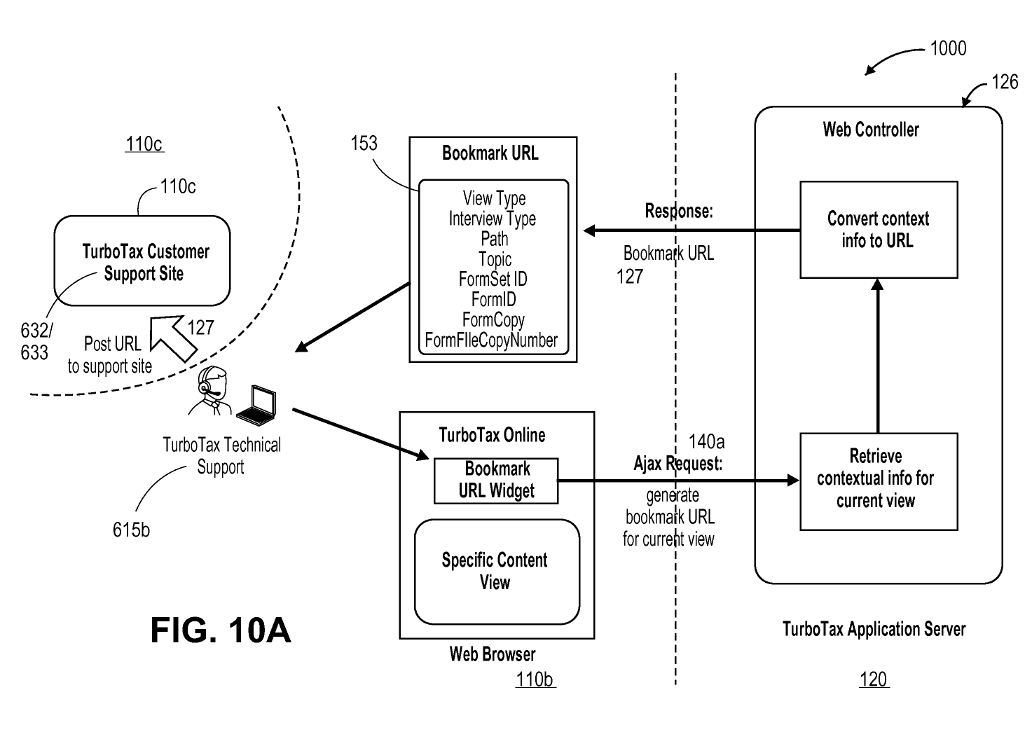

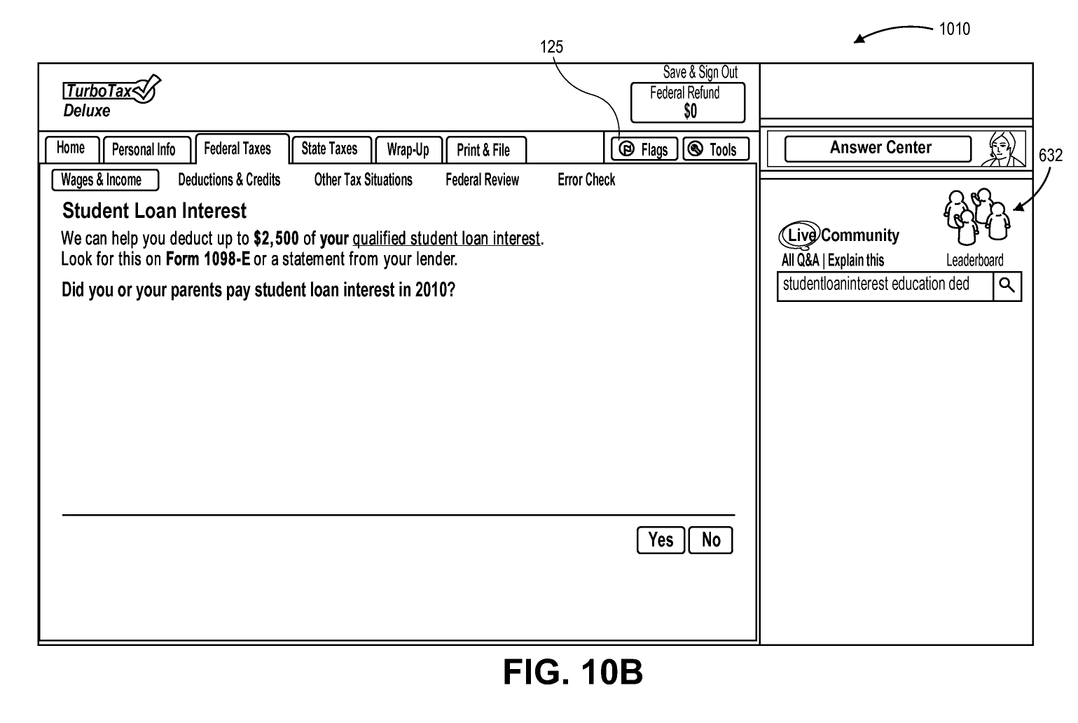

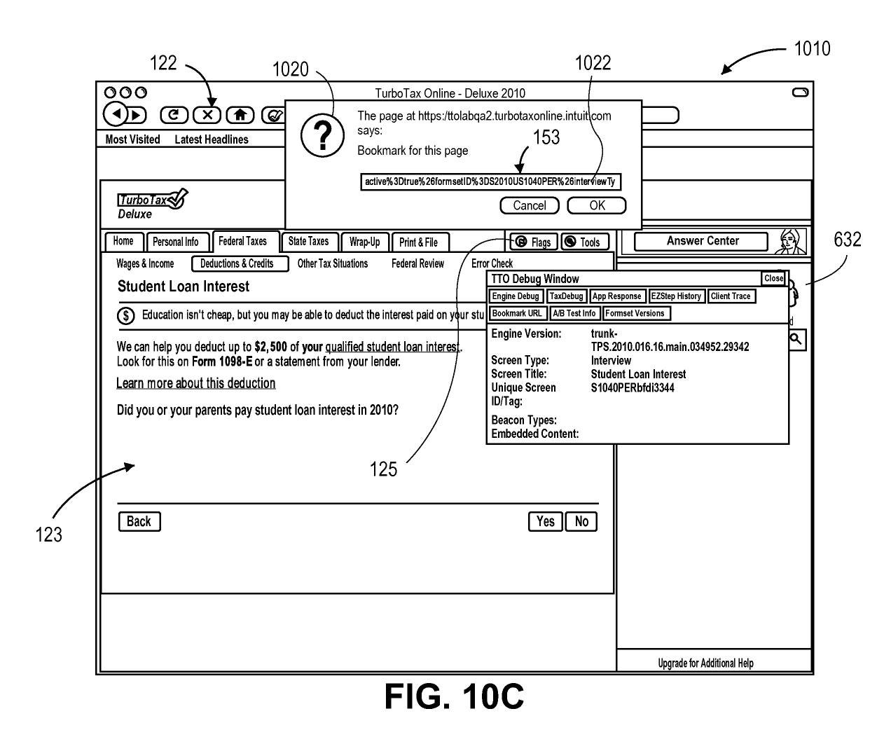

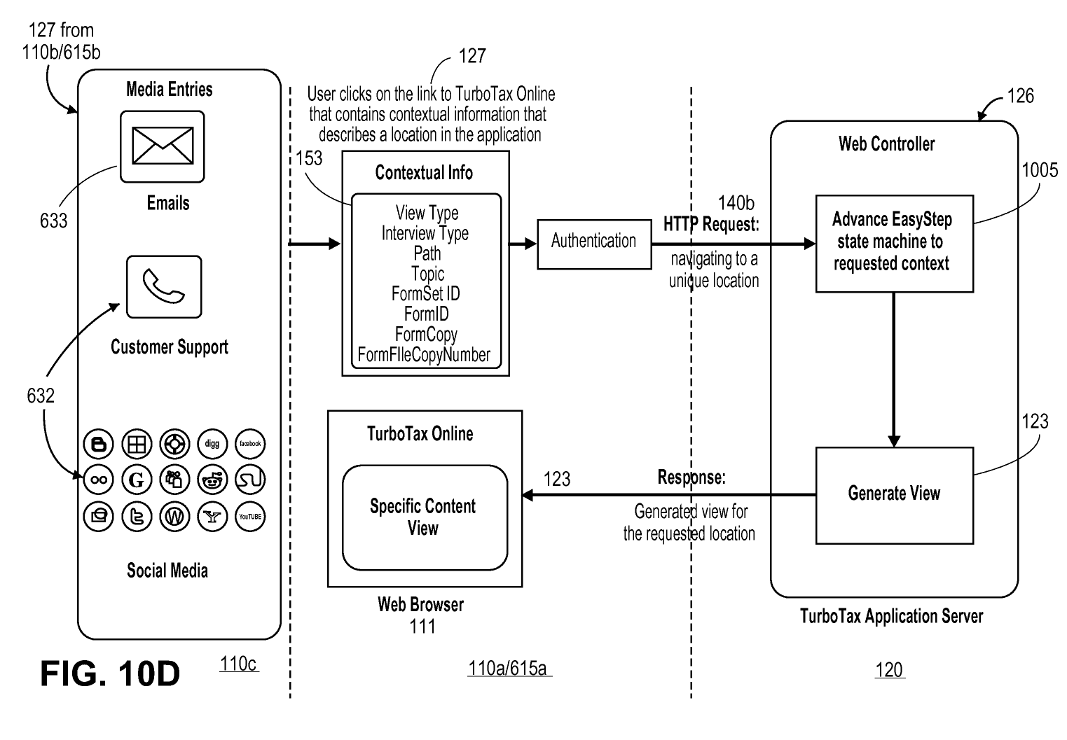

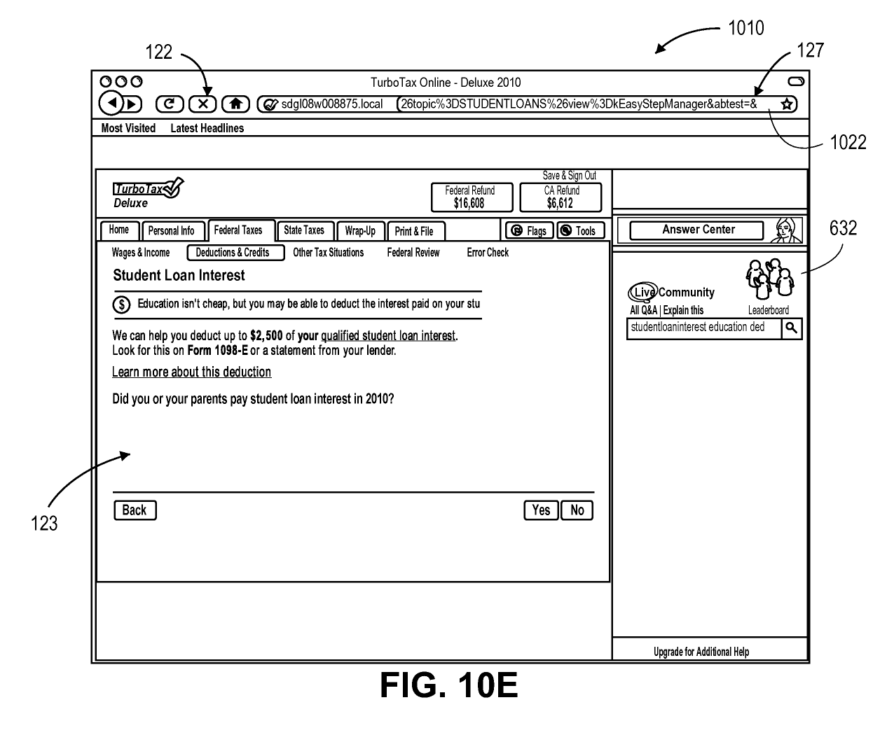

FIGS. 10A-C illustrate further examples of how system and method embodiments may be implemented with an on-line tax preparation application 621 of TURBO TAX to generate a link 127 embodying a URL address and post the link 127 to a computer 110 hosting a customer support website 632 such as LIVE COMMUNITY, and FIGS. 10D-E illustrate how system and method embodiments may be implemented with an on-line tax preparation application 621 of TURBO TAX to allow an end user 615a to click on link 127, e.g., within a different application, and be directed to a view of a screen 123 identified by context data 153 within the URL address of the link 127. It should be understood, however, that embodiments may be used with other on-line tax preparation applications 621, and that TURBO TAX is one example of a tax preparation application 621 that may include or be operable to execute embodiments for generating and navigating to URL bookmarks 127.

Referring to FIGS. 10A-C, one embodiment of a system 1000 for generating bookmarks 127 within an on-line tax preparation application 720 involves technical support person 615b who utilizes TURBOTAX and works with end users 615a to resolve end user questions with a customer or technical support site 632 such as LIVE COMMUNITY hosted by a computer 110c. For example, as discussed above with reference to FIG. 8, end user 615a may have a question about which interview screen 123 needs to be completed for a particular tax situation such as student loan interest. End user 615a contacts technical support person 615b, e.g., via the LIVE COMMUNITY website 632. Technical support person 615b reviews the question, utilizes a client or user computer 110 including a browser 111 to access the on-line tax preparation program 125.

Technical support person 615b is presented with a view including a user interface 122 for navigating screens 123 along various paths to the appropriate student loan interest screen 1010 as shown in FIG. 10B. As shown in FIG. 10C, technical support person 615b executes UI widget 125 (identified as “Flags” in FIGS. 10A and 10C) of on-line tax preparation application 621 to submit a request 140a, such as an AJAX request or other suitable request, from technical support person computer 110b to host computer 120 to generate a URL bookmark 127 for the current view or current screen 123. In the illustrated embodiment, clicking or activating the widget 125 displays a window 1020 with a URL address 1022 containing context data 153. Technical support person 615b clicks “OK” to submit request 140a, which is received by URL bookmark program 126 (illustrated as “web controller” in FIG. 10A) which, as described above, determines which screen 123 is the subject of the request 140a based at least in part upon the context data 153, generates a URL bookmark 127 based upon the context data 153 or, as shown in FIG. 10A, converts context data 153 into a corresponding URL bookmark 127, and then transmits the URL bookmark 127 to technical support person computer 110b. The previously described bookmark program 126 may be the web controller 1310 or a component thereof, and the controller 1302 may be programmed or configured to generate a URL bookmark 127 and generate a view of a screen 123 identified by the URL bookmark 127.

As generally illustrated in FIG. 10C, URL address 1022 of URL bookmark 127 may embody various types of context data 153 to identify the bookmarked screen and related screen data. According to embodiments, URL address 1022 may include one or more or all of the following types of context data 153 or attributes of on-line tax preparation application 621 such as TURBOTAX, which may be an element of the URL address generated to bookmark a specific screen 123:

“View Type,” which specifies how a user is viewing data, examples of which include (i.e., via Interview screen, or in forms view, or in print view),

“Interview Type,” which specifies the area within the application in which user is at currently, which may be a mechanism to break up the interview into manageable pieces,

“Path,” which specifies a path to a definition of a screen within a hierarchical or tree structure of a plurality of interview screens,

“Topic,” which specifies the endpoint in the path,

“FormSet ID,” which specifies the taxing agency for which the tax return is being prepared (Federal or state supported by the on-line tax preparation application),

“FormID,” which specifies internal data model that represents the taxing agencies tax forms,

“FormCopy,” which specifies a level of uniqueness if more than one form ID of the same name exist in the tax return, and

“FormFileCopyNumber,” which specifies an identifier that uniquely identifies every formID in the tax return.

It will be understood that other types of context data 153 and attributes may be utilized with different on-line tax preparation applications 621, and that these types of context data 153 are provided as examples of how embodiments may be implemented within TURBOTAX.

With continuing reference to FIGS. 10C-D, technical support person 615b receives the URL bookmark 127 and transmits the URL bookmark, e.g., in the form of a link, to the LIVE COMMUNITY support site 632 or another website or e-mail server. In this manner, end user 615a can access link 127. More particularly, referring to FIG. 10D, technical support person 615b may send link 127 to end user 615a directly or as shown in, for example, FIGS. 6B, 10A and 10D, indirectly as an electronic mail that is hosted by e-mail server 633 and can be downloaded or read using a mail program 631 or application such as MICROSOFT OUTLOOK. Link 127 may also be provided to a website 632, examples of which include a customer support website such as LIVE COMMUNITY and social networking websites such as FACEBOOK, MYSPACE, TWITTER, LINKEDIN, etc. (individual icons in FIG. 10D representing different websites such as social networking websites to which a link 127 may be posted). Such websites may be accessed using browser 111 such as INTERNET EXPLORER, MOZILLA FIREFOX and GOOGLE CHROME.

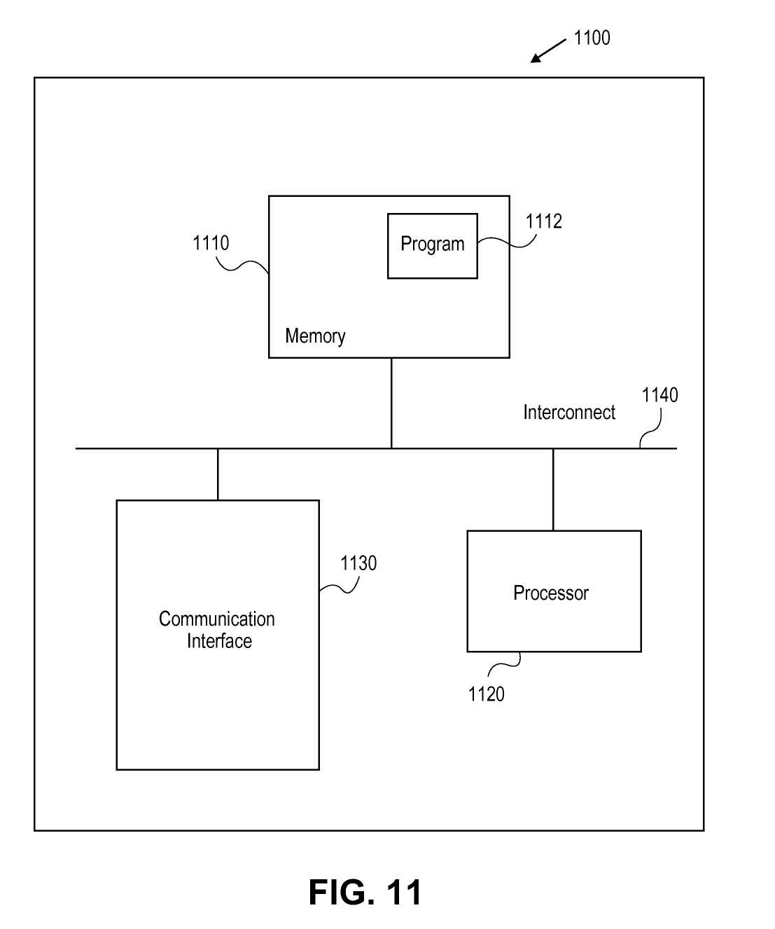

With continuing reference to FIG. 10D, and as explained above in further detail with reference to FIG. 9, end user 615a accesses the other application or program, clicks on the URL bookmark 127 such as a link embodying a URL address having context data 153 and that was generated by web controller or URL bookmark program 126, and submits a request 140b, such as a HTTP or other suitable request, to host computer 120 (TURBOTAX application server as shown in FIG. 10D) to navigate directly to a specific screen 123. End user 615a is authenticated as necessary, and HTTP request 140b is sent to web controller 126, which reads context data 153 of URL address of request 140b, identifies the corresponding screen 123, and advances a state machine 1005 to requested context data 153, thus generating a view of the URL bookmarked screen 123, which is displayed to the end user 615a on end user computer 110a. As shown in FIG. 11E, in this particular example, the screen 123 that was bookmarked according to embodiments was the screen 1010 related to student loan interest.

Thus, with embodiments, a UI element or widget 125 is used to request and generate URL bookmark 127, and the generation request may be submitted by the end user (e.g. as shown in FIG. 6A) or by someone else such as technical support person (e.g., as shown in FIGS. 6B and 10A-E). URL bookmark 127 may be in the form of a link embodying a URL address including context data 153 of the screen 123 to be bookmarked such that the link may be clicked or entered in a first application such as a browser 111 or e-mail application 631, to navigate to a specific screen 123 within a different, on-line tax preparation application 621. Thus, according to certain embodiments, the URL bookmark 127 is provided within or transmitted or posted to an application or program other than on-line tax preparation application 621, and end user 615a, while utilizing that other application, can jump directly to a screen 123 within on-line tax preparation application 621.

FIG. 11 illustrates components of a computing device 1100 that may be part of or used to implement embodiments. The computing device 1100 includes a memory 1110, program instructions 1112, a processor or controller 1120, a network or communications interface 1130, and connections or interconnect 1140 between such components. For example, the memory 1110 may be or include one or more of cache, RAM, ROM, SRAM, DRAM, RDRAM, EEPROM and other types of memory. The processor unit 1120 may be or include multiple processors, a single threaded processor, a multi-threaded processor, a multi-core processor, or other type of processor. Depending on the particular system component (e.g., whether the component is a computer or a hand held mobile communications device), the interconnect 1140 may include a system bus, LDT, PCI, ISA, or other types of buses, and the communications or network interface may, for example, be an Ethernet interface, a Frame Relay interface, or other interface. The network interface 1130 may be configured to enable a system component to communicate with other system components across a network which, as explained above, may be a wireless or various other networks. Accordingly, the system configuration provided in FIG. 11 is provided for ease of explanation and illustration to generally illustrate system components that may be utilized in various embodiments.

Method embodiments, e.g., embodiments of a bookmark program, controller, and/or tax preparation application, may also be embodied in, or readable from, a computer-readable medium or carrier, e.g., one or more of the fixed and/or removable data storage data devices and/or data communications devices connected to a computer. Carriers may be, for example, magnetic storage medium, optical storage medium and magneto-optical storage medium. Examples of carriers include, but are not limited to, a floppy diskette, a memory stick or a flash drive, CD-R, CD-RW, CD-ROM, DVD-R, and DVD-RW. The processor 1120 performs steps or executes program instructions 1112 within memory 1110 and/or embodied on the carrier to implement method embodiments.

Although particular embodiments have been shown and described, it should be understood that the above discussion is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims.

For example, it will be understood that while embodiments are described with reference to one user accessing a host computer, multiple user may access the host computer and the same AJAX application at the same or different times.

Additionally, embodiments may apply to various types of AJAX applications, including on-line tax preparation applications.

Further, while embodiments directed to on-line tax preparation applications may be utilized to prepare and electronically file tax returns for individuals and also corporate or business returns. While certain embodiments are described with reference to generating and navigating a URL bookmark for a particular screen, the user may generate multiple bookmarks for multiple screens, and different users may generate different numbers of URL bookmarks for respective screens. Thus, each user may generate one, two, five, ten, twenty and other numbers of URL bookmarks. Further, while embodiments are described with reference to URL bookmarks related to student loan interest, URL bookmarks may relate to various other topics within an electronic tax return such as income, deductions, taxes, business income, expenses, depreciation, etc., sales of stock and other securities, mortgage interest, property tax, child expenses, charitable contributions, exemptions and deductions and other tax-related information, etc.

Additionally, it will be understood that embodiments may involve sending a link to the user such that all the user has to do is click on the link. In other embodiments, the actual URL address can be provided. In both cases, the user may also share the link or URL address with other people such that others can also jump to the same page within the AJAX application such as an on-line tax preparation application. Such embodiments are better suited for cases in which users are not providing any personal or tax data and instead providing a link to an empty page in order to maintain confidentiality of sensitive tax return information.

Further, embodiments may involve both the same user computer being used to submit the request for the URL bookmark and receiving the URL address or link embodying the URL address and a first computer (e.g., a computer of a technical support person) requesting the URL bookmark or link and a second, different computer (e.g., a computer of an end user) being used to click on the link or enter the URL address to navigate directly to the bookmarked screen.

Where methods and steps described above indicate certain events occurring in certain order, those of ordinary skill in the art having the benefit of this disclosure would recognize that the ordering of certain steps may be modified and that such modifications are in accordance with the variations of the invention. Additionally, certain of the steps may be performed concurrently in a parallel process when possible, as well as performed sequentially.

Accordingly, embodiments are intended to exemplify alternatives, modifications, and equivalents that may fall within the scope of the claims.

What is claimed is:

1. A computer-implemented method for generating a bookmark of a screen of an on-line tax preparation application operable to prepare an electronic tax return, the method comprising:
determining context data associated with a selected screen of the on-line tax preparation application, the context data identifying a path to a location of the selected screen or definition thereof within a hierarchical data structure; and
generating a Uniform Resource Locator (URL) bookmark based at least in part upon the context data, the selected screen being directly accessible by a user of the on-line tax preparation application with the URL bookmark without the user navigating through any prior screens along the path to the selected screen.

2. The computer-implemented method of claim 1, the selected screen being accessible by utilizing the URL bookmark within a second application other than the on-line tax preparation application.

3. The computer-implemented method of claim 2, the on-line tax preparation application executing on a first computer and the second application executing on a second computer.

4. The method of claim 3, the second application comprising an electronic mail application or a website, the URL bookmark being transmitted as an electronic mail message and accessible with the electronic mail application or posted to the website.

5. The computer-implemented method of claim 1, the URL bookmark comprising a URL address including the context data identifying the selected screen.

6. The computer-implemented method of claim 1, the user comprising an end user of the on-line tax preparation application or a technical support person assisting the end user with an electronic tax return prepared using the on-line tax preparation application.

7. The computer-implemented method of claim 1, the method further comprising:
receiving, at a first computer hosting the on-line tax preparation application through a first network and from a second computer of the user of the on-line tax preparation application, a first request for the URL bookmark, the URL bookmark being dynamically generated in response to the first request; and
transmitting the URL bookmark from the first computer to the second computer in response to the first request.

8. The computer-implemented method of claim 7, the first request being generated by a widget executing on the second computer, the widget being displayed as an element of a user interface of the on-line tax preparation application and selected by the user to request the URL bookmark of the selected screen.

9. The computer-implemented method of claim 7, further comprising:
receiving, at the first computer and through a second network from a third computer of an end user of the on-line tax preparation application, a second request from the end user to navigate to the selected screen, the second request comprising context data of the generated URL bookmark for the selected screen;
determining the context data of the URL bookmark;
navigating the path to the selected screen using a state machine executing on the first computer; and
generating a view of the selected screen in response to the second request, the view being displayed on the third computer to the end user.

10. The computer-implemented method of claim 9, the URL bookmark comprising a link embodying the URL address that includes context data, the second request comprising the end user clicking on the link within a second application utilized by the end user other than the on-line tax preparation application.

11. The computer-implemented method of claim 10, the second application comprising an electronic mail application utilized to access the link in an electronic mail or a browser utilized to access the link within a website.

12. The computer-implemented method of claim 1, the URL bookmark being generated without Uniform Resource Locator (URL) hashing and independently of a bookmarking mechanism of a browser executing on the first computer.

13. The computer-implemented method of claim 1, further comprising:
determining second context data associated with a second selected screen of the on-line tax preparation application, the second context data identifying a second path different than the first path to a second location of the second selected screen or definition thereof within the hierarchical data structure; and
generating a second URL bookmark based at least in part upon the second context data, the second selected screen being directly accessible by a user of the on-line tax preparation application with the second URL bookmark.

14. The URL bookmark comprising a URL address including the context data or a link embodying the URL address.

15. A computer-implemented method for bookmarking a screen of an on-line tax preparation application hosted by a first computer and operable to prepare an electronic tax return, the method comprising:
utilizing a second computer to access the first computer and navigate a first path of the hierarchical structure of screens to a selected screen of the on-line tax preparation application;
transmitting a request to bookmark the selected screen from the second computer through a first network to the first computer; and
receiving a URL bookmark at the second computer from the first computer, the selected screen being directly accessible by a user of the on-line tax preparation application with the URL bookmark without the user navigating through any prior screens along the path to the selected screen.

16. The computer-implemented method of claim 15, the selected screen being accessible by utilizing the URL bookmark within a second application other than the on-line tax preparation application.

17. The computer-implemented method of claim 16, the second application comprising an electronic mail application utilized to access the URL bookmark in an electronic mail message or a browser utilized to access the URL bookmark within a website.

18. The computer-implemented method of claim 15, the URL bookmark including the context data identifying the selected screen.

19. The computer-implemented method of claim 15, the user comprising an end user of the on-line tax preparation application or a technical support person assisting the end user with an electronic tax return prepared using the on-line tax preparation application.

20. The computer-implemented method of claim 15, the request being generated by a widget executing on the second computer, the widget being displayed as an element of a user interface of the on-line tax preparation application and selected by a user of the second computer to request the URL bookmark.

21. The computer-implemented method of claim 1, further comprising:
utilizing the second computer to navigate a second path of the hierarchical structure to a second selected screen of the on-line tax preparation application;
transmitting a second request to bookmark the second selected screen from the second computer through a first network to the first computer; and
receiving a second URL bookmark at the second computer from the first computer, the second selected screen being directly accessible by the user of the on-line tax preparation application with the second URL bookmark without the user navigating through any prior screens along the second path to the second selected screen.

22. The computer-implemented method of claim 14, the URL bookmark comprising a URL address including the context data or a link embodying the URL address, the method comprising:
transmitting the URL address or the link from the second computer through a second network to a third computer hosting an application other than the on-line tax preparation application and that is utilized by an end user of the on-line tax preparation application.

23. The computer-implemented method of claim 22, the third computer hosting an electronic mail application, the URL address or link being transmitted in an electronic mail message.

24. The computer-implemented method of claim 23, the second application comprising an electronic mail application utilized to access the URL bookmark in an electronic mail message or a browser utilized to access the URL bookmark within a website.

25. The computer-implemented method of claim 24, the website comprising a technical support website or a social networking website.

26. A computer-implemented method for generating a bookmark of a screen of an on-line tax preparation application operable to prepare an electronic tax return, the method comprising:
receiving, at a first computer hosting the on-line tax preparation application through a first network and from a second computer of the user of the on-line tax preparation application, a request for a Uniform Resource Locator (URL) bookmark of a selected screen following navigation of a path of a hierarchical structure of screens to the selected screen by a user of the on-line tax preparation application;
determining context data associated with the selected screen, the context data identifying the path to the location of the selected screen or definition thereof within the hierarchical structure;
in response to the request, dynamically generating the URL bookmark based at least in part upon the determined context data; and
transmitting the URL bookmark from the first computer to the second computer in response to the first request, the URL bookmark comprising a link embodying a URL address including context data and being selectable by a user from within a second application other than the on-line tax preparation application without the user navigating through any prior screens along the path to the selected screen.

27. The computer-implemented method of claim 26, the request being generated by a widget executing on the second computer, the widget being displayed as an element of a user interface of the on-line tax preparation application and selected by a user of the second computer to request the URL bookmark.

28. The computer-implemented method of claim 26, further comprising:
receiving, at the first computer and through a second network from a third computer of an end user of the on-line tax preparation application, a second request from the end user to navigate to the selected screen, the second request comprising context data of the generated URL bookmark for the selected screen;
determining the context data of the URL bookmark;
navigating the path to the selected screen using a state machine executing on the first computer; and
generating a view of the selected screen in response to the second request, the view being displayed on the third computer to the end user.

29. The computer-implemented method of claim 28, the URL bookmark generated without Uniform Resource Locator (URL) hashing and independently of a bookmarking mechanism of a browser executing on the first computer.

30. A computer-implemented method for generating a bookmark of a screen of an Asynchronous JavaScript and XML (AJAX) application, the method comprising:
determining context data associated with a selected screen of the AJAX application, the context data identifying a path to a location of the selected screen or definition thereof within a hierarchical data structure; and
generating a Uniform Resource Locator (URL) bookmark based at least in part upon the context data, the selected screen being directly accessible by a user of the AJAX application with the URL bookmark without the user navigating through any prior screens along the path to the selected screen.

31. The computer-implemented method of claim 30, the selected screen being accessible by utilizing the URL bookmark within a second application other than the AJAX application.

32. The method of claim 32, the second application comprising an electronic mail application utilized to access the URL bookmark in an electronic mail message or a browser utilized to access the URL bookmark within a website.

33. The computer-implemented method of claim 30, the AJAX application being hosted by a first computer, the URL bookmark being generated in response to a first request received from a second computer and generated by a widget displayed as an element of a user interface of the AJAX application.

34. The computer-implemented method of claim 33, further comprising
receiving a second request to navigate to the selected screen from a third computer of an end user of the AJAX application at the first computer, the second request comprising context data of the generated URL bookmark for the selected screen;
determining the context data of the URL bookmark;
navigating the path to the selected screen using a state machine executing on the first computer; and
generating a view of the selected screen for display on a third computer of an end user of the AJAX application in response to a second request received at the first computer from the third computer.

35. The computer-implemented method of claim 1, the URL bookmark being generated without Uniform Resource Locator (URL) hashing and independently of a bookmarking mechanism of a browser executing on the first computer.

36. A computer-implemented method for bookmarking a screen of an Asynchronous JavaScript and XML (AJAX) application hosted by a first computer, the method comprising:
utilizing a second computer to access the first computer and navigate a first path of the hierarchical structure of screens to a selected screen of the AJAX application;
transmitting a request to bookmark the selected screen from the second computer through a first network to the first computer; and
receiving a URL bookmark at the second computer from the first computer, the selected screen being directly accessible by a user of the AJAX application with the URL bookmark without the user navigating through any prior screens along the path to the selected screen.

37. The computer-implemented method of claim 36, the selected screen being accessible by utilizing the URL bookmark within a second application other than the AJAX application.

38. The computer-implemented method of claim 36, the request being generated by a widget executing on the second computer, the widget being displayed as an element of a user interface of the AJAX application and selected by a user of the second computer to request the URL bookmark.

39. The computer-implemented method of claim 36, further comprising:
utilizing the second computer to access the first computer and navigate a second path of the hierarchical structure of screens to a second selected screen of the AJAX application;
transmitting a second request to bookmark the second selected screen from the second computer through the first network to the first computer; and
receiving a second URL bookmark at the second computer from the first computer, the second selected screen being directly accessible by a user of the AJAX application with the second URL bookmark without the user navigating through any prior screens along the second path to the second selected screen.

40. A computer-implemented method for generating a bookmark of a screen of an Asynchronous JavaScript and XML (AJAX) application, the method comprising:
receiving, at a first computer hosting the AJAX application through a first network and from a second computer of the user of the AJAX application, a request for a Uniform Resource Locator (URL) bookmark of a selected screen following navigation of a path of a hierarchical structure of screens to the selected screen by a user of the AJAX application;
determining context data associated with the selected screen, the context data identifying the path to the location of the selected screen or definition thereof within the hierarchical structure;
in response to the request, dynamically generating the URL bookmark based at least in part upon the determined context data;
transmitting the URL bookmark from the first computer to the second computer in response to the first request, the URL bookmark comprising a link embodying a URL address including context data and being selectable by a user from within a second application other than the AJAX application without the user navigating through any prior screens along the path to the selected screen.
